(19) United States
(12) Patent Application Publication
(10) Pub. No.: US 2003/0140626 A1
(43) Pub. Date: Jul. 31, 2003

(54) Hydraulic system for a working machine that comprises a special consumer

(76) Inventors: Jurgen Schenk, Stuttgart (DE); Frank Tegethoff, Hoxter (DE)

Correspondence Address: VENABLE, BAETJER, HOWARD AND CIVILETTI, LLP, P.O. BOX 34385, WASHINGTON, DC, 20043-9998, US

(21) Appl. No.: 10/332,855

(22) PCT Filed: Jul. 12, 2001
(86) PCT No.: PCT/DE01/02599

(30) Foreign Application Priority Data
Jul. 14, 2000 (DE) 100 34 431.3

(51) Int. Cl. F16D 31/02

(52) U.S. Cl. 60/422

(57) ABSTRACT

A hydraulic system for excavators or other working machines, comprising a branching device for feeding special consumers with particularly high power consumption. The special consumer is supplied with priority until a maximum supply level is reached, which is lower than the maximum output of the hydraulic source. The remaining output difference is made available without restriction to the other consumers in the hydraulic system, wherein the distribution of the remaining flow of hydraulic fluid is not influenced. Thus, the operating ability of the machine equipped with the hydraulic system is maintained completely and in the standard manner. Any possible slow-down of the adjustment movement of a consumer is reflected proportionally in the movements of all other consumers, so that the ratios of the operating speeds or reaction speeds of the individual consumers among themselves remain the same.

The invention relates to a hydraulic system that is designed to supply a single consumer with high power consumption, as well as additional consumers. The invention furthermore relates to a corresponding method.

Excavators and other working machines are generally provided with a hydraulic system for operating various hydraulic elements. The hydraulic system includes a pump unit, for example with a liquid output of several 100 liters/minute up to a maximum pressure of several 100 bar. The pump unit is generally used to operate several consumers, for example hydraulic cylinders that coordinate the movement of a dredging shovel. Additional functions, such as the swiveling or turning of an excavator, the opening and closing of grippers, and the like are also realized with hydraulic drives, which are all supplied by the joint pump unit.

In addition to the hydraulic elements on the working machines, it is sometimes necessary to connect additional devices, which are hooked to the hydraulic system for the power supply. Consumers of this type are, for example, milling units used to break up solid cover layers (asphalt) or other types of hard layers. Milling units of this type consume relatively high amounts of power and swallow correspondingly high amounts of the supplied hydraulic fluid. Working machines are frequently not designed and/or equipped for connecting additional devices of this type. In addition, this is somewhat problematic since adding a consumer with high fluid consumption can influence or interrupt the supply of hydraulic fluid to the other consumers of the hydraulic system. Extensive interventions in the hydraulic system of a working machine should also be avoided on principle, so as not to interrupt the balanced operation of the other connected consumers. For example, an excavator operator always expects the movements of the individual hydraulic cylinders to be at a constant ratio to each other once the valves are opened correspondingly, even if the hydraulic pump output changes.

Thus, it is the object of the invention to create the option of easily connecting a special consumer with high power consumption to an existing hydraulic system while for the most part avoiding interruptions to the other consumers.

This object is solved with the hydraulic system having the features as defined in patent claim 1. Accordingly, the object is solved with the methods detailed in claim 10 for operating a device of this type:

The hydraulic system according to the invention is provided with a pump unit for hydraulic fluid, which supplies hydraulic fluid up to a maximum pressure and a maximum output volume. The pump unit is controlled by an electric, hydraulic or electrohydraulic control device, which in the ideal case can be used to influence the pressure and the output of the pump unit. With simpler embodiments, it is also possible in some circumstances to control to a higher or lesser degree only the output pressure or only the output.

In the final analysis, the pump unit is used to supply consumers having a total output capacity that exceeds in most cases the output of the pump unit. This is particularly true if a special consumer with especially high fluid consumption, meaning high power consumption, is added to these consumers. For example, this can be a milling unit. Additional consumers such as hydraulic cylinders, hydraulic motors or the like, which must be present on the working machine in any case, are supplied with hydraulic fluid via a main slide-valve unit. The main slide-valve unit distributes the hydraulic fluid arriving from the pump unit to the individual consumers, in accordance with control commands. The control commands, for example, can be input manually by an excavator operator who activates corresponding levers. The main control unit is preferably designed such that it can maintain constant ratios between the maximum fluid flows that can be supplied to the individual consumers, for the most part independent of the flow and pressure of the arriving hydraulic fluid.

A branching device is therefore inserted into the connecting line between the pump unit and the main slide-valve unit to supply the special consumer. This branching device supplies the special consumer via a branch line. The branch line in this case is designed such that it supplies the special consumer with a minimum flow of hydraulic fluid, even if the main slide-valve unit supplies other consumers with hydraulic fluid. By diverting hydraulic fluid in front of the main slide-valve unit, all other consumers are equally disadvantaged, so that the ratio between the respective maximum amounts supplied to the other consumers remains constant. The operation of the remaining hydraulic elements is thus slowed down when the special consumer is started up, but not in a disproportionate manner. In addition, sufficient hydraulic capacity is always made available to the remaining hydraulic elements. The continued operation of all consumers is therefore ensured even if the milling unit is operational. The disadvantage experienced by the remaining consumers can be compensated, however, by readjusting the drive motor, for example by giving more gas to the motor if the branching device is activated.

If no hydraulic fluid is dispensed at the main slide-valve unit, then 100% of the hydraulic output can be funneled to the special consumer. At the same time, the operating ability of the remaining consumers is maintained in that sufficient pressure is present at the main slide-valve unit to supply the connected consumers as required. All hydraulic functions are therefore maintained.

The intervention in the hydraulic system of the working machine, required because of the branching device, is slight and can occur mostly independent of the exact configuration of this hydraulic system. In particular, this is important for possible retrofitting options, meaning for hydraulic systems where the manufacturer initially did not provide connections for a special consumer. No changes have to be made or interventions are required either on the pump unit or the main slide-valve unit. The branching device thus permits creating a simple add-on system that can be integrated into different, existing hydraulic systems. Thus, special consumers can be connected even to those working machines, which are not originally designed for this.

If necessary, the branching device ensures a minimum flow of hydraulic fluid to the special consumer. However, this fluid flow is preferably limited to a maximum, which is lower than the maximum output of the pump unit. A reserve is thus maintained for the remaining consumers, which ensures the orderly operation of the remaining working machine when the special consumer is operational. A volume-flow-limiting device that is arranged in the branching device, for example, can be used for this. The volume-flow-limiting device preferably is adjusted to supply the special consumer with the highest priority, until the maximum volume flow is reached. The highest priority of the special consumer only extends up to that value. Any additional output amounts made available by the pump unit, on the other hand, are supplied with the highest priority to the remaining consumers to maintain their operation.

The volume-flow-limiting device is preferably adjusted such that it delivers at most 80% of the maximum volume flow to the special consumer.

The branching device preferably comprises a pressure controller for maintaining a constant pressure supplied to the special consumer. Alternatively, a constant volume flow to the special consumer can be adjusted to maintain, for example, a constant speed for a milling unit. For one preferred embodiment, the volume flow as well as the available hydraulic pressure can be adjusted. The pressure control and the volume-flow control can be distributed over different load ranges of the special consumer, for example, so as to operate with a constant volume flow (speed) at lower loads and a constant pressure (rotational moment) at higher loads. In addition, a defined pressure-volume-course P=f(U) or U=g(P) can be preset. A computerized control in particular can be used for this, which controls a pressure regulator and a volume-flow regulator in the branching device by supplying these with fixed or changeable preset values.

A control signal for controlling the pump unit can furthermore be derived from the branching device, which ensures that the pump unit provides hydraulic power only as needed. The control signal derived from the branching device, for example, can be combined with another control signal to form a total control signal, wherein signals can in principle be added. However, it has proven advantageous if the signals are linked in such a way that the respectively larger signal is used as the lead signal for the pump unit.

During the start-up or shutdown of the special consumer, the branching device is preferably controlled such that the pressure and/or the volume flow of hydraulic fluid are respectively turned on or turned off according to a predetermined characteristic curve or a predetermined time curve. The pressure as well as the volume of the hydraulic flow can be controlled separately during the start-up and the shutdown of the special consumer.

The branching device and the pump can be controlled with an electronic control device. This device permits, for example, the adjustment of a predetermined high pump output (e.g. 100%) when the additional consumer is added, independent of other signals.

For one preferred embodiment, the flow and/or the pressure in the branch line leading to the special consumer is controlled or regulated in dependence on the pressure or the volume flow of another consumer. Alternatively, the flow or the pressure of the fluid supplied to another consumer is regulated or controlled by the flow or the pressure to the special consumer. This is of considerable importance in practical operations, for example for controlling a milling unit in dependence on its forward feed or for controlling its forward feed in dependence on the milling unit operation. For example, the driving speed of the drive gear for an excavator or other working machine can be adapted to the resistance momentarily encountered by the milling unit. If the swiveling movement of an extension arm or boom determines the forward feed of the milling unit, then its movement can be controlled in dependence on the milling capacity. Furthermore, it is possible to control the contact pressure of the milling unit or another variable in dependence on the milling capacity, for example by controlling the drive unit or the hydraulic equipment of a boom.

To control the special consumer, the control device can also be controlled with the aid of additional signals. For example, the milling unit can be turned off following a load-free maximum operating period or when reaching or exceeding a specific position, which can serve as a safety aspect.

The hydraulic system of one advantageous embodiment includes a device for the automatic detection of the special consumer, wherein the special consumer is provided with a machine-readable code. A reader is used to detect the special consumer. Data stored in a memory can then be used to pre-adjust or control the branching device accordingly.

Further details of advantageous embodiments of the invention follow from the drawing, the specification or one and/or several dependent claims. Exemplary embodiments of the invention are illustrated in the drawing. Shown are in:

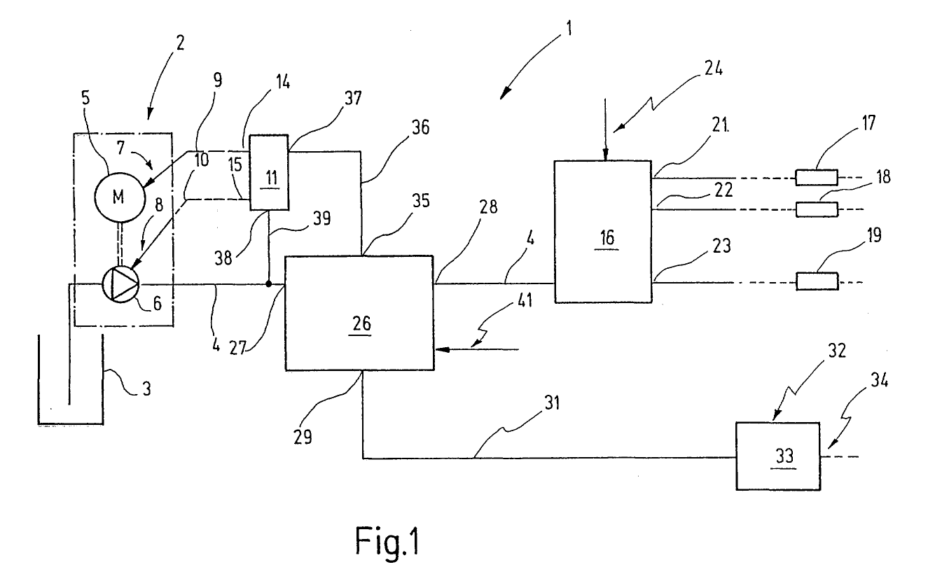

FIG. 1 A schematic representation of the configuration of a hydraulic system with a connection for a special consumer;

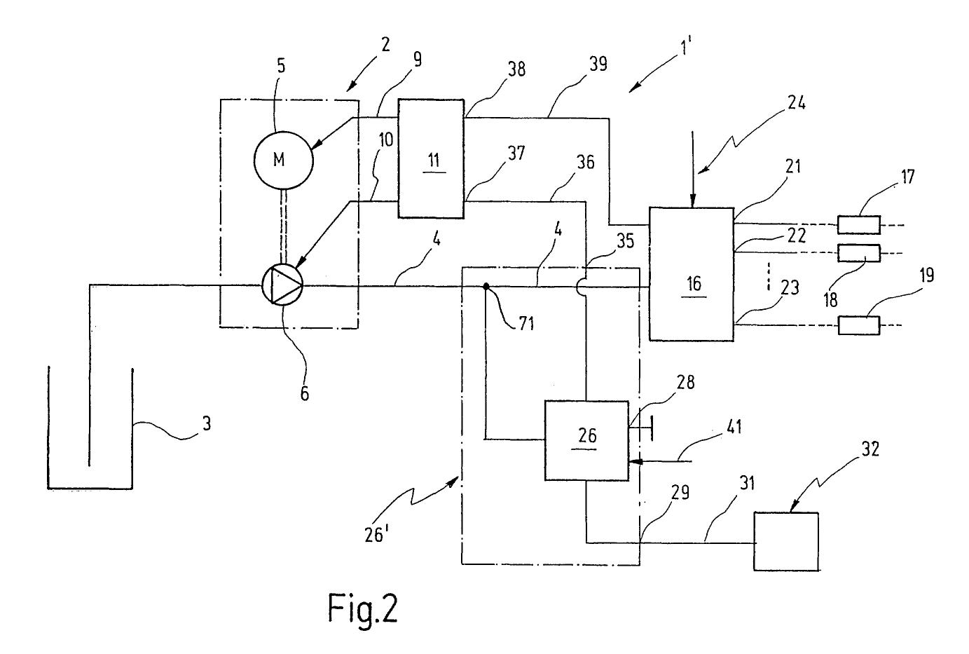

FIG. 2 A modified embodiment of the hydraulic system according to FIG. 1;

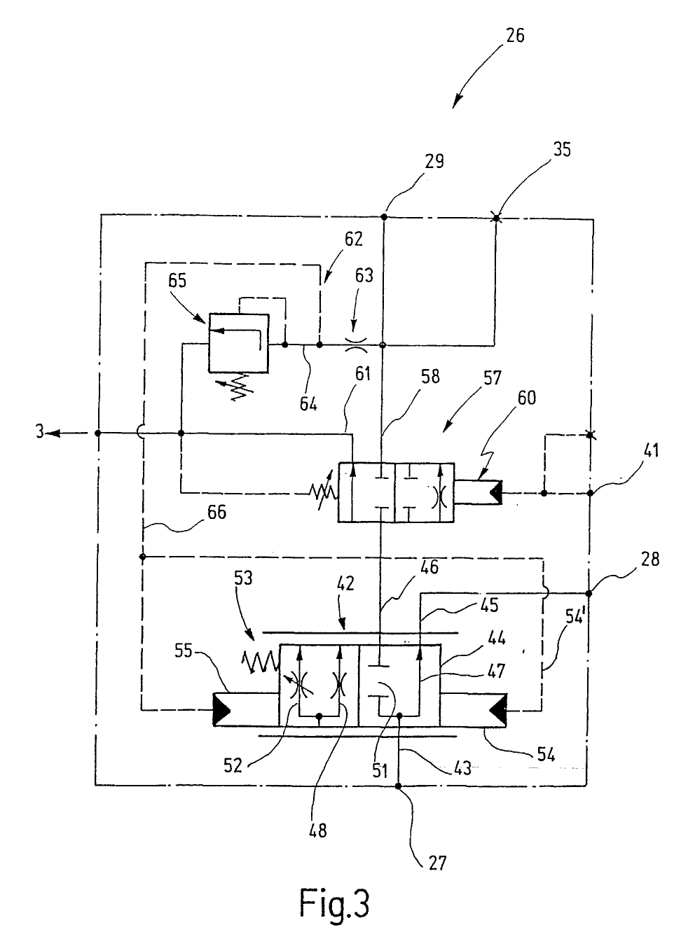

FIG. 3 A branching device for a hydraulic system according to FIG. 1 or 2, shown as schematic block diagram;

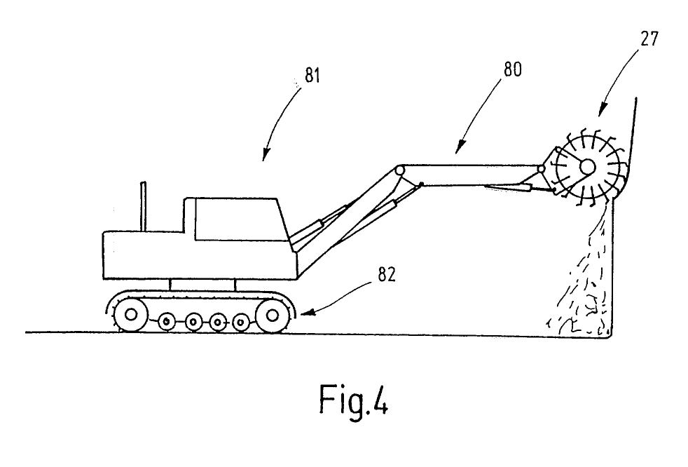

FIG. 4 A schematic illustration of an excavator with a milling unit on a vertical wall; and

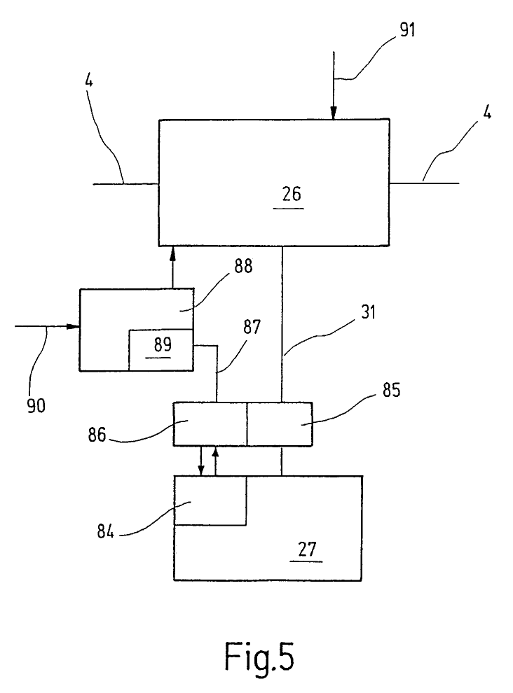

FIG. 5 A modified version of the hydraulic system according to the invention in a schematic representation.

FIG. 1 shows details of a hydraulic system for a working machine, for example an excavator, in an extremely schematic block diagram. The hydraulic system 1 includes a pump unit 2, which functions to pump hydraulic fluid from a storage container 3 into a line 4. The pump unit comprises a drive motor 5, for example the diesel motor of an excavator, as well as a pump 6 that is driven by the drive motor 5. The drive motor 5 as well as the pump 6 can be provided with control inputs 7, 8, which are connected to corresponding signal lines 9, 10 to control the drive motor 5 and/or the pump 8. The rotational moment and/or the speed of the drive motor 5 and the output of the pump 6 can thus be purposefully influenced with a control device 11, having corresponding outputs 14, 15 that are connected to the control lines 9, 10.

The pump unit 2 is connected via the line 4 to a main slide-valve unit 16, which functions to distribute the hydraulic fluid to several consumers 17, 18, 19. To connect these consumers, the main slide-valve unit 16 is provided with several output connections 21, 22, 23. The main slide-valve unit 16 is furthermore provided with several operating elements 24, which are shown only symbolically in FIG. 1. When these operating elements are actuated, the output connections 21 to 23 are respectively supplied individually with hydraulic fluid. The main slide-valve unit 16 in this case is configured such that the hydraulic fluid made available at the line 4 is distributed to the individual output connections 21, 22, 23, as predetermined by the actuation of the operating elements 24. The maximum flows at the individual output connections 21 to 23 are at a fixed ratio to each other to keep the movement speed ratio among the individual, connected hydraulic elements (consumers 17, 18, 19) constant.

The line 4 leads through a branching device 26 that functions to divert the hydraulic fluid from the line 4 with the highest priority until it reaches a maximum volume flow. Only the remaining residual volume flow is made available to the main slide-valve unit 16 to be distributed to the consumers 17, 18, 19. For this, the branching device 26 is provided with an input connection 27 and an output connection 28. The line 4 of a working machine such as an excavator, which is originally designed to be a through line, is divided for this and is connected to the input connection 27 as well as the output connection 28. Via a branch output 29, the branching device 26 feeds a branch line 31 that leads to a special consumer 32, for example a milling unit 33. A return line 34 leads from the special consumer 32 back to the storage container 3, as is also the case for the main control unit 16 and/or the consumers 17, 18, 19.

The branching device 26 furthermore has a control output 35 that is connected via a signal line 36 to a corresponding input 37 of the control device 11. If necessary, the control device 11 can additionally be provided with a control input 38 that is connected via a control line 39 to the line 4, either in front of or behind the branching device 26.

For the targeted actuation of the special consumer 32, the branching device 26 is provided with a control input 41 that is subject to the arbitrary control by an operator. For example, the control input 41 can either be an electrical input or a hydraulic input, which is supplied via an actuation element with a signal that can be manually influenced.

The branching device 26 is shown separately in FIG. 3. The branching device 26 contains a distribution valve 42 with an input 43, which is connected to the input for the branching device 26. The valve comprises a valve member 44 for controlling the distribution of the flow of hydraulic fluid arriving at the input 43, such that it flows to a first output 45 and a second output 46. The first output 45 is directly connected to the output connection 28. The valve member 44 is designed to completely open up the path leading from the input 43 to the output 45 (path 47) in one extreme position and to reduce the connection between the input 43 and the output (path 48) in the other extreme position. The reduction in the flow of hydraulic fluid between the input 43 and the output 45 is for the most part proportionally reflected in the position of the valve member 44.

The valve member 44 is furthermore designed such that the flow-through between the input 43 and the output 46 is closed off completely in one position (path 51), whereas it is opened with adjustable reduction in the other extreme position of valve member 44 (path 52). The valve 42 thus has the characteristic of a crossover or reversing valve.

A spring 53 is used to position the valve member 44 of the distribution valve 42, which spring places the valve element into a preferred position in which the paths 48, 52 are active (right extreme position, not shown in FIG. 3). Two fluid adjustment elements 54, 55, arranged so as to be effective in opposite directions, furthermore function to position the valve member 44. Thus, the position of valve member 44 in the final analysis corresponds to the pressure difference of the pressures in the fluid adjustment elements 54, 55.

A control valve 57 is connected to the connection 46 of distribution valve 42. The output 58 of this control valve is conducted to the branch connection 29 and thus controls the branch line 31. The control valve 57 functions to start up and shut down and/or control the special consumer 32.

The control valve 57 controls two paths going in opposite directions. A first path, extending from the output 46 of distribution valve 42 to the output 58 of control valve 57 is closed when the valve is in the rest position and is opened up with a reduced cross section in the other valve position, wherein this reduction can be adjustable. The transition from the closed state to the reduced opened state can be approximately proportional to the positioning of the valve-closing member. A second path is arranged in a control channel 61 and is controlled to run counter to the first path. In the valve rest position, the channel 61 is completely open and in the opposite position, it is completely closed off. The control valve 57 is activated with the aid of a hydraulic element 60, which receives a pressure signal from the control input 41. The valve output 58 not only leads to the output connection 29, but additionally also to the control output 35, where it is possible to tap the pressure that is present on the output side at the branching device 26. In addition, the output 58 functions to supply a control circuit 62 by way of a throttle 63 that branches off from the output 58. The control circuit 62 is a volume-flow-control device.

The throttle 63 feeds a line 64 that empties out into a reservoir 3 via a constant pressure regulator 65. An essentially constant pressure is thus adjusted in the line 64, provided a sufficient pressure exists at the output 58 of control valve 57 and the line 64 is not pressure-relieved via the control valve 57. A corresponding control line 66 leads from the line 64 to the control channel of the control valve 57. This control channel either creates a connection between the control valve 57 and the control line 61 (pressure relief), depending on the valve position, or more or less severs this connection. In addition, the control line 66 leads to the hydraulic adjustment element 55 and is used to position the valve member 44 in accordance with the pressure difference between the hydraulic adjustment elements 54, 55. The hydraulic adjustment element 54 is admitted with pressure at the output 46.

The hydraulic system 1 described so far operates as follows:

The initial assumption is that the special consumer 32 must not be actuated. The control valve illustrated in FIG. 3 accordingly is also not actuated, meaning the control input 41 does not receive a signal. The control valve 57 thus is in the position shown in the drawing and the branch connection 29 is without pressure. However, the full pressure of the pump unit 2 is present at the input connection 27. The spring 53 briefly positions the valve member 44 in such a way that the path 52 is opened slightly. The hydraulic pressure that is effective directly from the input connection 27 to the output 46, travels via the respective channel 54′ to the hydraulic adjustment element 54, which immediately adjusts the valve element to full throughput (path 47) between the input connection 27 (input 43) and the output connection 28 (output 45). The branching device 26 thus has connected the input connection 27 without flow reduction to the output connection 28. The total hydraulic output made available by the pump unit 2 is then transferred to the main slide-valve unit 16. The motor performance and the speed and/or the output of the pump 6 can then be controlled as needed via the control line 39 and the control device 11.

The control input 41 of the branching device 26 is provided with a corresponding pressure signal for operating the special consumer 32 (milling unit 33). The control valve 57 is correspondingly adjusted, so that a through connection is created from the output 46 of the distribution valve 42 to the branch connection 29. This (reduced) throughput allows hydraulic fluid to be transferred. A pressure drop at the output 46 is counter-acted with an immediate, corresponding adjustment of the valve member 44, which then increasingly opens up the channel 52. A pressure drop at the output 46 signifies an immediate pressure drop at the hydraulic adjustment element 54, so that a smaller force counteracts the force exerted by the spring 53 and the valve member 44 is adjusted correspondingly. Simultaneously with the pressure applied in this way to the branch connection 29, the control circuit 62 is provided with hydraulic fluid via the throttle 63. The pressure control valve 65 constantly adjusts this pressure, wherein the pressure relief in the control line 66, which exists during the rest position, is now reduced via the control valve 57. The pressure in the control line 66 accordingly increases maximally to the value preset by the pressure control valve 65. As a result, the hydraulic adjustment element 55 is effective in the same direction as the spring 53. Hydraulic fluid is then present at the branch 29 and the throughput to the branch 29 as well as the throughput to the output connection 28 are reduced (paths 52, 48).

The branching device 26 limits the volume flow to the branch connection 29 to a maximum value that is preset by the control valve 57. If an attempt is made to tap more hydraulic fluid at the branch connection 29 than is preset by the position of control valve 57, the pressure inside the control circuit 62 can no longer be maintained and the pressure at the hydraulic element 55 also drops accordingly. In that case, the force of the hydraulic adjustment element 54 becomes dominant, thus causing a higher reduction in the path leading from the input 43 to the output 46, thereby limiting the volume flow. Vice versa, if not enough fluid is tapped at the branch connection 29, more hydraulic fluid is made available in that the valve member 44 is moved in the opposite direction.

The branching device 26 furthermore causes the pressure at the branch connection 29 to be limited. If the pressure at the branch connection is too high, the control channel 54′ pressure increases simultaneously. Thus, the path leading from the input 43 to the output 46 is increasingly reduced (path 51) as a result of a corresponding adjustment of the valve member 44. With lower counter pressures, the volume flow preset by the signal at the control connection 41 is thus released at the branch connection 29. With higher counter pressures, the pressure is limited.

The branching device illustrated in FIG. 3 can also be used with hydraulic systems where the pump unit 2 is controlled by a load signal, which is derived from the main slide-valve unit 16. FIG. 2 shows a hydraulic system 1′ of this type. Insofar as the operation is identical or similar to the previously described embodiment, we refer to the above description. The previously introduced reference numbers are therefore used and are not described or referred to again. The above description applies correspondingly. Above all, this embodiment differs from the above-described embodiment in that the control device 11 receives a load control signal not only or not exclusively from the line 4, but also from the main slide-valve unit 16 or other sources provided on the respective consumers 17, 18, 19. Whereas the distribution valve 42 for the above-described embodiment made it possible to reduce the flow between the input connection 27 and the output connection 28 (path 48) somewhat if the special consumer 32 was activated, the line 4 in the embodiment according to FIG. 2 is tapped only via a branch 71. The branch 71 here belongs to a branching device 26′, which in the final analysis is formed by the branching device 26 and the branch 71. The branching device 26 completely coincides with the device shown in FIG. 3, wherein the output connection 28 is blocked. The distribution valve 42 henceforth only regulates the branch line 31, but not the line 4. The control device 11 evaluates the load signals arriving at the control lines 36, 39. In that case, the pump unit 2 can be actuated corresponding to the sum of both signals, at least until the maximum capacity for the pump unit is reached. Alternatively, the pump unit 2 can also be controlled so as to correspond only to the respectively higher load signal. In any case, the branching device 26 and/or 26′ diverts a volume flow from the line 4, which is sufficient to operate the special consumer 32 without interrupting the operation of the consumer 17, 18, 19.

In addition, it is possible to use the load signal present at the control output 35, which characterizes the load at the special consumer 27, for controlling one of the consumers 17, 18, 19. The consumers 16, 17, 18 can be hydraulic cylinders of a boom 80 for an excavator 81, which carries a milling unit as special consumer 27 in place of a dredging shovel. The consumer 17, 18, 19 furthermore can be a drive unit 82 for the excavator. Depending on the type of use, the boom 80 or the drive unit 82 can be controlled proportional or reverse proportional to the load signal or based on a characteristic curve that is preset and, if necessary, also depends on the type of existing or detected special tool.

FIG. 5 shows a different modified and/or supplemented version of the hydraulic system illustrated so far. The special consumer 27 carries a machine-readable marking 84, e.g. a barcode, an electric or a magnetic signal transmitter 83. A mechanical coupling functions as mechanical connection between the special consumer 27 with boom 80, which preferably also includes a hydraulic coupling 85. In addition, this coupling is also provided with or connected to a reader 86 for the marking 84, or is connected to this reader. Via a line 87, the reader 86 transmits signals to a control device 88, which characterizes the detected marking 84. The connected special consumer 27 is identified with the aid of comparison data, which can be stored in a memory 86 that belongs to the control device 88. Control data or preset values that are manually entered, for example via a control input 90, are converted by the control device with the aid of the type of special consumer that is detected into correspondingly sensible actuation signals for the branching device 26. The branching device 26 can also be provided with control signals via its own control input 91.

The control device 88 furthermore can be designed such that it controls at least one of the consumers 17, 18, 19. For example, it can preset a constant contact pressure or a constant forward feed for the milling unit if the drive unit and/or one or several cylinders of the boom 80 are also controlled. A controlled reduction or influencing of the flow of hydraulic fluid that is conducted via the line 4 to the main slide-valve unit 16 by the branching device is thus possible. For example, if the operation of one hydraulic cylinder is to be slowed down, the line 4 is reduced. If the operation of the cylinder is to be accelerated, the line is opened up more. Via the branching device, the control device 88 thus can purposely influence the operation of the consumers arranged downstream of and controlled by the main slide-valve unit 16.

A hydraulic system 1 for excavators or other working machines contains a branching device 26 for feeding special consumers 32 with especially high power consumption. The special consumer 32 is supplied with priority up to a maximum supply level, which is lower than the maximum output of the hydraulic source 2. The remaining difference is made available without restriction to the other consumers of the hydraulic system, wherein the distribution of the remaining hydraulic flow is not influenced. Thus, the operating capacity of the machine provided with the hydraulic system 1 is maintained completely and in the usual manner. A possible slowing of the adjustment movement of a consumer is reflected proportionally in the adjustment movements of all other consumers, so that the ratios of the working speeds or reaction speeds of the individual consumers among themselves remain the same.

1. A hydraulic system (1) with a connection (29) for a special consumer (32) with high power consumption, in particular for a milling unit (33), said system comprising
a pump unit (2) for hydraulic fluid,
a control device (11) for controlling the pump unit (2),
a main slide-valve unit (16) that is connected via a line (4) to the pump unit (2) and is provided with several controlled output connections (21, 22, 23) for consumers (17, 18, 19),
a branching device (26) that is installed in the line (4) and functions to divert with the highest priority a minimum flow of hydraulic fluid from the line (4) into a branch line (31) and an output connection (29) for supplying the special consumer (32), even if other connections (21, 22, 23) at the main slide-valve unit (16) are supplied with hydraulic fluid.

2. The hydraulic system according to claim 1, characterized in that the branching device (26) comprises a volume-flow-limiting device (57, 62), which is arranged in front of the branch line (31) and which maximally feeds a volume flow to the output connection (29) that is lower than the maximum volume flow pumped by the pump unit (2).

3. The hydraulic system according to claim 2, characterized in that the volume flow diverted by the branching device amounts to maximum 80% of the volume flow supplied by the pump unit (2).

4. The hydraulic system according to claim 1, characterized in that the branching device (62) [sic] comprises a pressure controller (54), which maintains a constant pressure for the volume flow directed to the branch line (31) or which limits this pressure to a maximum value.

5. The hydraulic system according to claim 1, characterized in that the pump unit (2) has at least one control input (7, 8) and that the pressure of the released hydraulic fluid can be controlled on the basis of a signal present at the control input (7, 8).

6. The hydraulic system according to claim 5, characterized in that the branching device (26) has a control output (35), which is connected directly or indirectly to the control input (7, 8) of the pump unit (2), so that the output amount at the pump unit (2) is sufficient for keeping the pressure at the control output (35) constant.

7. The hydraulic system according to claim 5, characterized in that a control device (11) is arranged as link between the control input (7, 8) of the pump unit (2) and the control output (35) of the branching device (26), wherein this control device has at least two inputs (37, 38) and at least one output (14, 15) and transmits the input signal to its output (14, 15), which requires a comparably higher pump output, or which transmits an output signal that is formed by adding both input signals.

8. The hydraulic system according to claim 1, characterized in that the special consumer (32) is a milling unit (33) and that during the startup and shutdown of the special consumer, the branching device (26) respectively turns the pressure and/or volume flow of hydraulic fluid on or off, in each case according to a predetermined characteristic curve or a predetermined time curve.

9. The hydraulic system according to claim 1, characterized in that the special consumer (32) carries a machine-readable marking (84) and that a reader (86) is arranged on the working machine, which is designed to detect the marking and to transmit signals that correspond to the marking (84) to a control device (88), wherein the control device (88) is provided with a memory (89) that assigns adjustment parameters to the signals from the reader (86), which are then supplied to the branching device (26) for a corresponding control of this device.

10. A method for operating a hydraulic device with high power or fluid consumption as part of a hydraulic system for a working machine, wherein this method calls for diverting a flow of hydraulic fluid for operating a working machine from a flow of hydraulic fluid that is supplied from a pump unit to a main slide-valve unit and wherein the diverted fluid flow has priority over all other consumers until a limit value is reached.

11. The method according to claim 10, characterized in that the limit value amounts to a fraction, preferably 80%, of the maximum output of the pump unit.
